(19) United States
(12) Patent Application Publication
(10) Pub. No.: US 2011/0013388 A1
(43) Pub. Date: Jan. 20, 2011

(54) LIGHT STRING ASSEMBLY

(76) Inventor: Chen-Sheng YANG, Kaohsiung (TW)

Correspondence Address: RABIN & Berdo, PC, 1101 14TH STREET, NW, SUITE 500, WASHINGTON, DC, 20005, US

(21) Appl. No.: 12/502,632

(22) Filed: Jul. 14, 2009

(51) Int. Cl. F21S 4/00

(52) U.S. Cl. 362/227

(57) ABSTRACT

A light string assembly has a plug, an extension socket, a light string, a resistor and a reference diode. The plug is adapted to connect to an AC power. The light string is electrically connected between the plug and the extension socket and has multiple lighting units connected in series. The resistor is electrically connected to the light string in series. The reference diode is connected to the resistor in parallel in a reverse-biased direction. The reference diode avoids over-voltage across the resistor and thereby protects the resistor and the lighting units of the light string from damage.

### BACKGROUND OF THE INVENTION

1. Field of the Invention

The present invention relates to a light string assembly, especially to a light string assembly using a reference diode to protect lighting units when an unintentional short circuit occurs.

2. Description of Related Art

With reference to FIG. 4, a conventional light string assembly comprises a plug (60), an extension socket (61), multiple light emitting diodes (LEDs) (62) and a resistor (63). The plug (60) is adapted to electrically connect to an AC power. The extension socket (61) is adapted to correspondingly connect to a plug of another same light string. The light emitting diodes (LEDs) (62) and the resistor (63) are connected in series between the plug (60) and the extension socket (61). The resistor (63) limits electric current of the light string.

However, when a short circuit occurs in the light string assembly, the electric current will become too great for the resistor (63) and will overheat and damage the resistor (63) and the light emitting diodes (LEDs) (62).

To overcome the shortcomings, the present invention provides a light string assembly to mitigate or obviate the aforementioned problems.

### SUMMARY OF THE INVENTION

The main objective of the present invention is to provide a light string assembly using a reference diode to keep lighting units from burning out when an unintentional short circuit occurs.

To accomplish the objective, the light string assembly has a plug, an extension socket, a light string, a resistor and a reference diode.

The plug is adapted to connect to an AC power. The light string is electrically connected between the plug and the extension socket and has multiple lighting units connected in series. The resistor is electrically connected to the light string in series. The reference diode is connected to the resistor in parallel in a reverse-biased direction. The reference diode avoids over-voltage across the resistor and thereby protects the resistor and the lighting units of the light string from damage.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a first embodiment of a light string assembly in accordance with the present invention;

FIG. 2 is a circuit diagram of a second embodiment of a light string assembly in accordance with the present invention;

FIG. 3 is a circuit diagram of a third embodiment of a light string assembly in accordance with the present invention; and

FIG. 4 is a circuit diagram of a conventional light string assembly in accordance with the present invention.

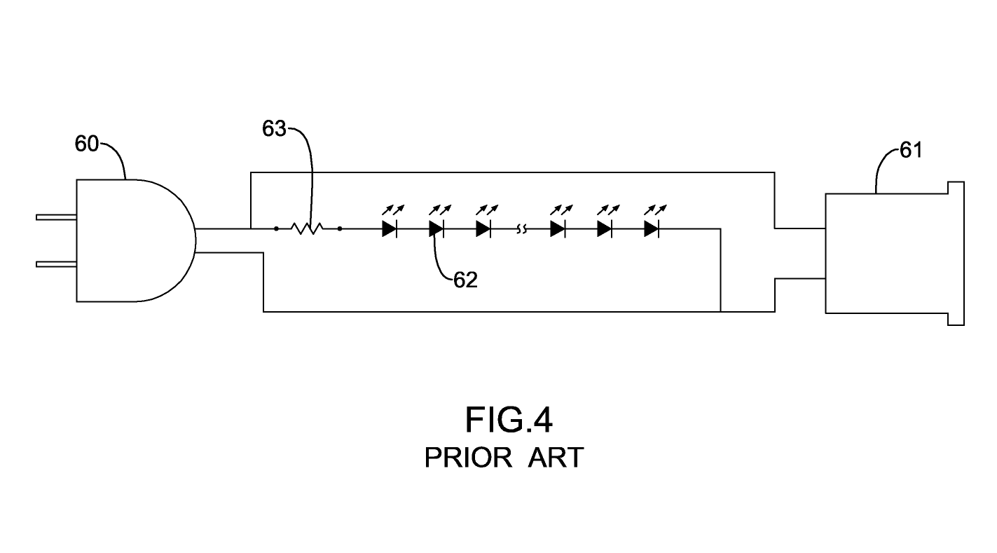

### DETAILED DESCRIPTION OF THE PREFERRED EMBODIMENT

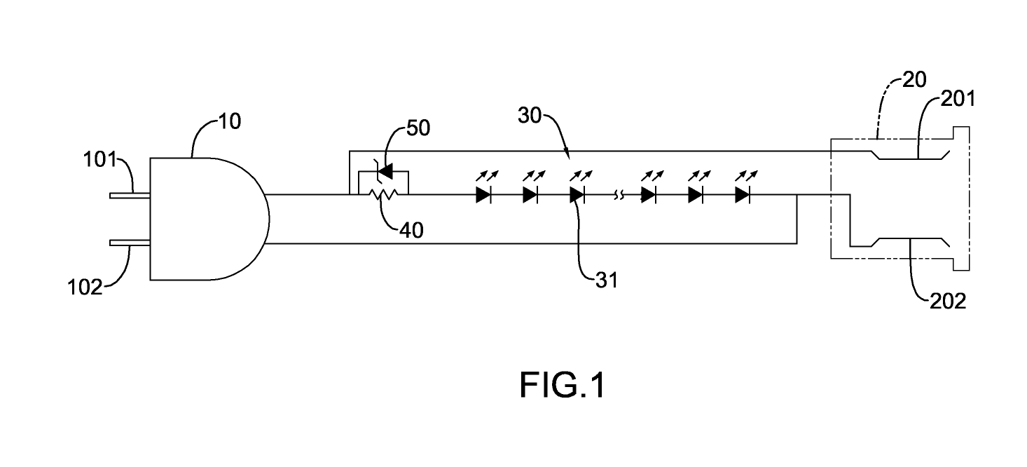

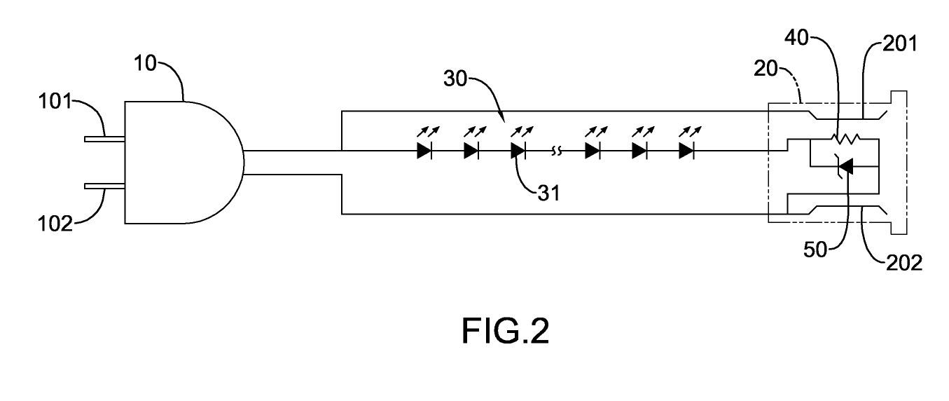

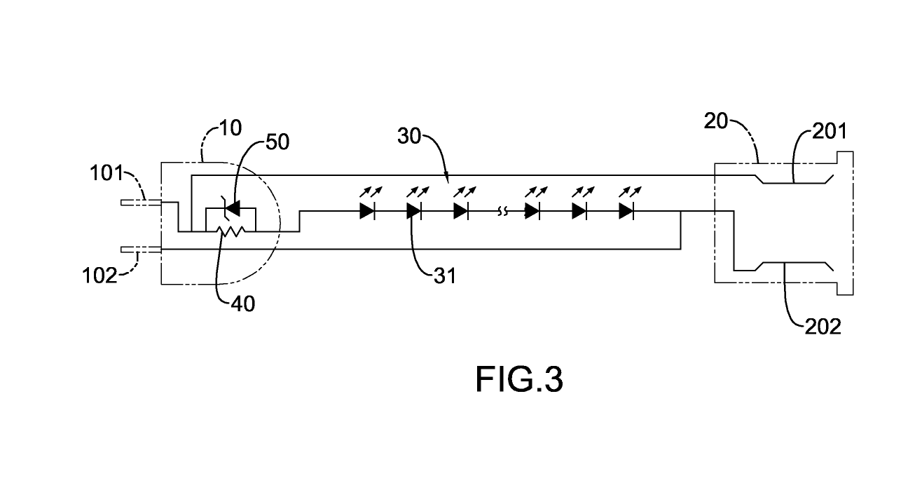

With reference to FIGS. 1, 2 and 3, a light string assembly in accordance with the present invention comprises a plug (10), an extension socket (20), a light string (30), a resistor (40) and a reference diode (50).

The plug (10) is adapted to connect to an AC power and has a first contact (101) and a second contact (102).

The extension socket (20) is adapted to connect a plug of another same light string assembly and has a first contact (201) and a second contact (202).

The light string (30) is electrically connected between the plug (10) and the extension socket (20) and has a front terminal, a rear terminal and multiple lighting units (31). The front terminal is electrically connected to the first contacts (101, 201) of the plug (10) and the extension socket (20). The rear terminal is electrically connected to the second contacts (102, 202) of the plug (10) and the extension socket (20). The lighting units (31) are connected between the front terminal and the rear terminal in series and may be implemented as light emitting diodes (LEDs).

The resistor (40) is electrically connected to the light string (30) in series, may be connected to the front terminal or the rear terminal of the light string.

The reference diode (50) is connected to the resistor (40) in parallel in a reverse-biased direction and may be implemented as a Zener Diode. The reference diode (50) and the resistor (40) may be integrated with the plug (10) or the extension socket (20).

When a short circuit occurs, the reference diode (50) will maintain a fixed voltage cross the resistor (40) to avoid over-voltage and thereby protects the resistor (40) and the lighting units (31) of the light string (30) from burning out. Hence the light string assembly is safe. Furthermore, the resistor (40) and the reference diode (50) can be integrated with the plug (10) or the extension socket (20) to maintain an aesthetic appearance of the light string assembly.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A light string assembly comprising:
a plug adapted to connect to an AC power and having a first contact and a second contact;
an extension socket having a first contact and a second contact;
a light string electrically connected between the plug and the extension socket and has
a front terminal electrically connected to the first contacts of the plug and the extension socket;
a rear terminal electrically connected to the second contacts of the plug and the extension socket; and
multiple lighting units connected between the front terminal and the rear terminal in series;
a resistor electrically connected to the light string in series; and
a reference diode connected to the resistor in parallel in a reverse-biased direction.

2. The Light string assembly as claimed in claim 1, wherein the reference diode and the resistor are integrated with the plug.

3. The Light string assembly as claimed in claim 1, wherein the reference diode and the resistor are integrated with the extension socket.

4. The Light string assembly as claimed in claim 1, wherein the reference diode is a Zener diode.

5. The Light string assembly as claimed in claim 2, wherein the reference diode is a Zener diode.

6. The Light string assembly as claimed in claim 3, wherein the reference diode is a Zener diode.
